(19) United States
(12) Patent Application Publication
(10) Pub. No.: US 2008/0108329 A1
(43) Pub. Date: May 8, 2008

(54) Mobile terminal and method and medium for controlling the same

(75) Inventors: Sung-mun Cho, Suwon-si (KR); Sang-on Choi, Suwon-si (KR); Woo-jong Cho, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/898,508

(22) Filed: Sep. 12, 2007

(30) Foreign Application Priority Data
Nov. 3, 2006 (KR) 10-2006-0108503

(51) Int. Cl. H04M 11/10; H04B 1/034; H04M 1/02

(52) U.S. Cl. 455/413; 455/566; 455/567; 455/99

(57) ABSTRACT

The present invention relates to a mobile terminal having a terrestrial magnetic sensor and a method and medium for controlling a mobile terminal. The mobile terminal compares a reference offset value of the terrestrial magnetic sensor and an offset value of the terrestrial magnetic sensor that is measured when the mobile terminal is being used, controls switching of an operation mode of the mobile terminal into a first safe mode on the basis of the comparison result. Further, the mobile terminal compares a reference signal variation of the terrestrial magnetic sensor and a terrestrial magnetic signal variation measured when the mobile terminal is being used, and controls switching of the operation mode of the mobile terminal into a second safe mode on the basis of the comparison result.

### CROSS-REFERENCE TO RELATED APPLICATIONS

This application claims the priority benefit of Korean Patent Application No. 10-2006-0108503 filed on Nov. 3, 2006 in the Korean Intellectual Property Office, the disclosure of which is incorporated herein by reference in its entirety.

### BACKGROUND OF THE INVENTION

1. Field of the Invention

The present invention relates to a mobile terminal that, using a terrestrial magnetic sensor mounted on the mobile terminal, recognizes whether or not a mobile terminal is located in a vehicle or the vehicle is moving, thereby keeping or switching an operation mode of the mobile terminal and a method and medium for controlling the same.

2. Description of the Related Art

It is widely known that the use of a mobile terminal during driving causes the risk of a traffic accident. In spite of using a call-subsidiary unit, such as a hands-free, the use of the mobile terminal during driving may increase the risk of a traffic accident since a driver does not pay attention to only driving.

A terrestrial magnetic sensor is used to measure the strength and direction of the terrestrial magnetism that a human cannot feel. As the terrestrial magnetic sensor, a flux-gate terrestrial magnetic sensor that uses a flux-gate to measure the terrestrial magnetism may be exemplified. In the flux gate terrestrial magnetic sensor, a material having high magnetic permeability, such as permalloy, is used for a core. An excitation magnetic field is generated through a coil that is wound around the core. The size and direction of an external magnetic field is measured by measuring a second harmonic component proportional to the external magnetic field to be generated according to magnetic saturation and nonlinear magnetic characteristics.

Recently, with the development of the MEMS (Micro Electro Mechanical System) technology, a subminiature flux-gate type terrestrial magnetic sensor having low power consumption can be manufactured. The subminiature flux-gate type terrestrial magnetic sensor is incorporated into various portable electronic apparatuses, such as a cellular phone, a PDA, a notebook computer, and the like.

Generally, as the terrestrial magnetic sensor, a two-axis terrestrial magnetic sensor having an X axis and a Y axis perpendicular to each other, or a three-axis terrestrial magnetic sensor having X, Y, and Z axes perpendicular to one another is used.

A mobile terminal having the terrestrial magnetic sensor controls an operation mode thereof on the basis of a signal detected by the terrestrial magnetic sensor. Therefore, the risk of a traffic accident of a user who possesses the mobile terminal in a vehicle can be lowered.

FIG. 1 is a conceptual view showing a case where a traveling state of a vehicle is detected by an inertial sensor (acceleration sensor or angular speed sensor).

The inertial sensor mounted in the vehicle shown in FIG. 1 includes a sensor module 102 that detects the movement of the vehicle, and a control unit 104 that determines whether or not to move the vehicle on the basis of a signal detected by the inertial sensor. The sensor module 102 generates a sensor signal corresponding to the traveling state of the vehicle and the control unit 104 determines whether or not to move the vehicle on the basis of the generated sensor signal. As shown in FIG. 1, the inertial sensor can detect the traveling state of the vehicle but the inertial sensor cannot detect whether a movable inertial sensor is mounted in the vehicle.

Accordingly, there is a need for a technology that can determine the traveling state of the vehicle on the basis of the signal detected by the inertial sensor and determine whether or not the inertial sensor is mounted in the vehicle by the user.

### SUMMARY OF THE INVENTION

According to an aspect of the present invention, there is provided a mobile terminal having a terrestrial magnetic sensor that compares a measured offset value of the terrestrial magnetic sensor and a predetermined reference range of an offset value of the terrestrial magnetic sensor, switches an operation mode of the mobile terminal into a first safe mode when the mobile terminal is located in a vehicle, on the basis of the comparison result, and automatically informs that a user of the mobile terminal is riding on the vehicle to a mobile terminal of a caller.

According to an aspect of the present invention, there is provided a mobile terminal that compares a currently measured signal variation of a terrestrial magnetic sensor and a reference signal variation of the terrestrial magnetic sensor stored in advance, and, on the basis of the comparison result, switches an operation mode of the mobile terminal into a second safe mode when the vehicle, on which the user having the mobile terminal is riding, is moving.

According to an aspect of the present invention, there is provided a mobile terminal that compares a currently measured acceleration sensor signal variation or an angular speed sensor signal variation and a corresponding reference signal variation stored in advance, and, on the basis of the comparison result, switches an operation mode of the mobile terminal into a second safe mode when the vehicle, on which the user having the mobile terminal is riding, is moving.

According to an aspect of the present invention, there is provided a method of controlling a mobile terminal, the method including extracting a reference offset value of a terrestrial magnetic sensor, measuring an offset value of the terrestrial magnetic sensor, comparing the measured offset value and the reference offset value, and switching an operation mode into a first safe mode when the measured offset value falls within a reference range based on the reference offset value.

According to another aspect of the present invention, there is provided a method of controlling a mobile terminal, the method including extracting a reference signal variation of a sensor module having one or more sensors, measuring a signal variation of the sensor module, comparing the measured signal variation and the reference signal variation, and switching an operation mode into a second safe mode when the measured signal variation is larger than the reference signal variation.

According to still another aspect of the present invention, there is provided a mobile terminal, the mobile terminal including a terrestrial magnetic sensor to measure an offset value of a sensed terrestrial magnetic signal, a comparison arithmetic unit to compare the measured offset value and a reference offset value of the terrestrial magnetic sensor, and a control unit to switch an operation mode into a first safe mode when the measured offset value falls within a reference range based on the reference offset value.

According to yet still another aspect of the present invention, there is provided a mobile terminal, the mobile terminal including a sensor module to measure a signal variation using one or more sensors, a comparison arithmetic unit to compare the measured signal variation and a reference signal variation, and a control unit to switch an operation mode into a second safe mode when the measured signal variation is larger than the reference signal variation.

According to another aspect of the present invention, there is provided at least one computer readable medium storing computer readable instructions to implement methods of the present invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a conceptual view showing a traveling state of a vehicle detected by an inertial sensor (acceleration sensor or angular speed sensor);

FIG. 2 is a block diagram showing the structure of a mobile terminal according to an exemplary embodiment of the present invention;

FIG. 3 is a graph showing a change in offset value of a terrestrial magnetic sensor in the mobile terminal mounted on a vehicle according to an exemplary embodiment of the present invention;

FIG. 4 is a block diagram showing the structure of a sensor module according to an exemplary embodiment of the present invention;

FIG. 5 is a block diagram showing the structure of a sensor module according to another exemplary embodiment of the present invention;

FIG. 6 is a block diagram showing the structure of a sensor module according to still another exemplary embodiment of the present invention;

FIG. 7 is a block diagram showing the structure of a mobile terminal according to another exemplary embodiment of the present invention;

FIG. 8 is a flowchart showing a process of controlling a mobile terminal according to an exemplary embodiment of the present invention; and

FIG. 9 is a flowchart showing a process of controlling a mobile terminal according to another exemplary embodiment of the present invention.

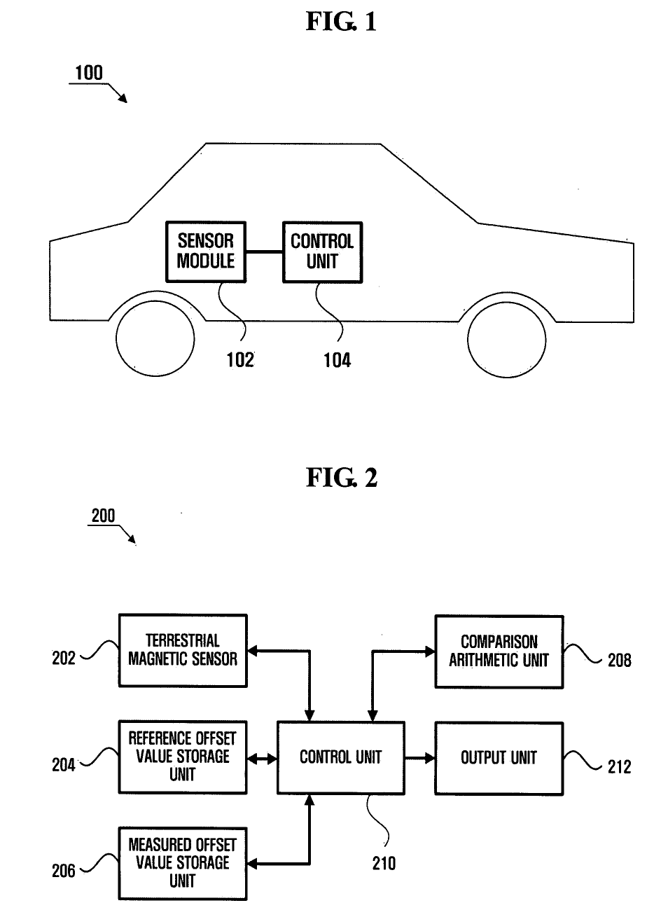

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

FIG. 2 is a block diagram showing the structure of a mobile terminal (mobile computing device) according to an exemplary embodiment of the present invention. A mobile terminal (mobile computing device) may be any portable electronic apparatus such as a cell/mobile phone, personal digital assistant (PDA), notebook computer, portable media player, portable game player, and the like.

Referring to FIG. 2, the mobile terminal includes a terrestrial magnetic sensor 202, a reference offset value storage unit 204 of the terrestrial magnetic sensor 202, a measured offset value storage unit 206 of the terrestrial magnetic sensor 202, a comparison arithmetic unit 208, a control unit 210, and an output unit 212.

The terrestrial magnetic sensor 202 detects a weak terrestrial magnetic field that a human cannot feel and generates an electric signal corresponding to the detection result. At this time, the terrestrial magnetic sensor 202 has an offset value peculiar to the generated electric signal and stores the offset value in the reference offset value storage unit 204. A reference offset value of the terrestrial magnetic sensor 202 may be measured and stored in advance or may be newly measured and stored according to a key input signal of a user.

An offset value measured under a general use environment of the terrestrial magnetic sensor 202 is stored in the measured offset value storage unit 206. The reference offset value and the measured offset value of the terrestrial magnetic sensor 202 are compared with each other by the comparison arithmetic unit 208. The control unit 210 controls an operation mode of the mobile terminal on the basis of the comparison result.

Here, the operation mode includes a first safe mode, a second safe mode, and a third safe mode. According to the operation mode, it is determined whether or not to output a ringtone or to transmit a message (voice message or text message).

Then, the output unit 212 outputs the ringtone or transmits the message according to the operation mode switched by the control unit 210.

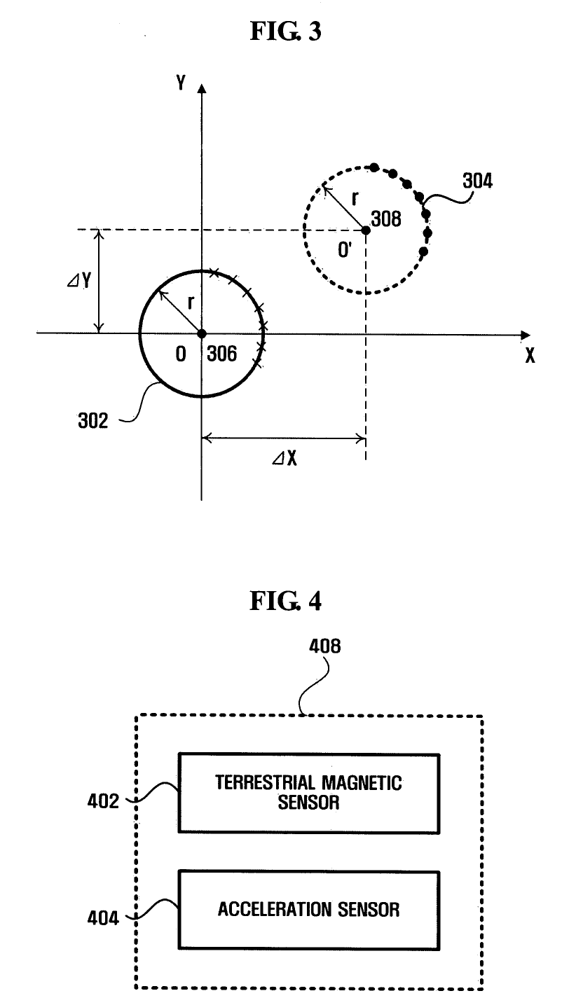

FIG. 3 is a graph showing a change in the offset value of the terrestrial magnetic sensor in the mobile terminal mounted on a vehicle. The graph of FIG. 3 shows an X-axis value and a Y-axis value of the two-axis terrestrial magnetic sensor 202 in the mobile terminal according to an exemplary embodiment of the present invention on a two-dimensional plane. In a case where the mobile terminal belongs to an ideal terrestrial magnetic field, the X-axis value and the Y-axis value of the two-axis terrestrial magnetic sensor 202 are represented by a solid line circle 302, and an offset value of the terrestrial magnetic sensor 202 is represented by a center point O 306 of the solid line circle 302.

At this time, a signal generated by the terrestrial magnetic sensor 202 is represented on a circumference having a predetermined radius r from the center O 306. If a three-axis terrestrial magnetic sensor 202 is provided in the mobile terminal, a Z-axis is added to be perpendicular to the plane of the X axis and Y axis perpendicular to each other. Accordingly, a signal of the three-axis terrestrial magnetic sensor 202 is represented by a coordinate point (an X-axis signal, a Y-axis signal, and a Z-axis signal) at a surface of a three-dimensional sphere. If the mobile terminal is located within the vehicle, the offset values of the X-axis and the Y-axis change due to an effect of metal elements of the vehicle. Therefore, like a circle 304 indicated by a dotted line shown in FIG. 3, the center moves by ΔX and ΔY in the X-axis direction and the Y-axis direction, respectively, from the original center point O and is then represented as a point O′ 308. When the values of the signals of the X axis and the Y axis are represented on the two-dimensional coordinate, the values are represented on the circumference of the circle 304 and have a radius r′ from the center O′. As a general method of measuring the offset value of the terrestrial magnetic sensor 202, there is known a method of calculating a center point by modeling a circle using predetermined coordinate values obtained through measurement for a predetermined time.

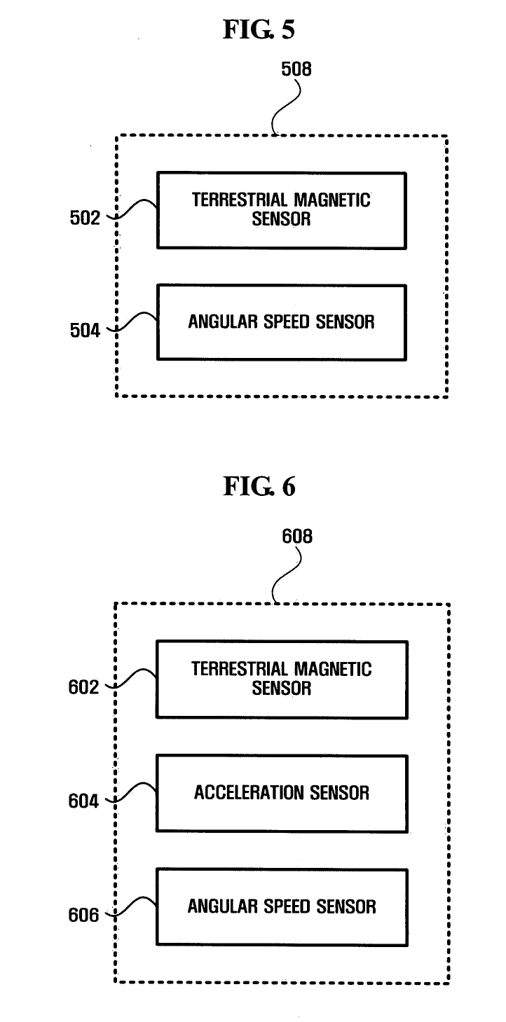

The mobile terminal according to an exemplary embodiment of the present invention may include a predetermined sensor module having one or more sensors, in addition to the terrestrial magnetic sensor 202. FIG. 4 shows a sensor module 408 having a terrestrial magnetic sensor 402 and an acceleration sensor 404. FIG. 5 shows a sensor module 508 having a terrestrial magnetic sensor 502 and an angular speed sensor 504. FIG. 6 shows a sensor module 608 having a terrestrial magnetic sensor 602, an acceleration sensor 604, and an angular speed sensor 606.

That is, the mobile terminal according to an exemplary embodiment of the present invention may determine, using a signal detected by one or more sensors, whether or not a user is riding on a vehicle or the vehicle is moving.

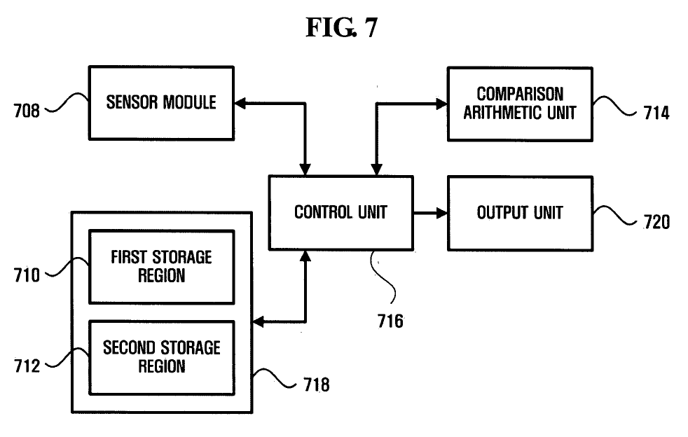

FIG. 7 is a block diagram showing the structure of a mobile terminal (mobile device) according to another exemplary embodiment of the present invention. The mobile terminal includes a sensor module 708, a storage unit 718 that has a first storage region 710 for storing a reference sensor signal variation of each sensor generated by the sensor module 708 and a second storage region 712 for storing a measured sensor signal variation, a comparison arithmetic unit 714 that reads out the reference value and the measured value from the storage unit 718 and performs a comparison arithmetic of the reference value and the measured value, a control unit 716 that controls the operation mode of the mobile terminal on the basis of the comparison arithmetic result, and an output unit 720 that outputs a ringtone or transmits a message corresponding to the operation mode.

Here, when it is assumed that a measured value of a currently sensed sensor signal is represented by X(t) and a measured value of a sensor signal detected immediately before the current signal is represented by X(t−1), the sensor signal variation may be defined as {X(t)−X(t−1)}. In order to distinguish the sensor signal variation from a noise level to be measured when the mobile terminal including the sensor module 708 does not move, the reference sensor signal variation may be defined by a value to which a margin to be obtained through an experiment is added to the noise level.

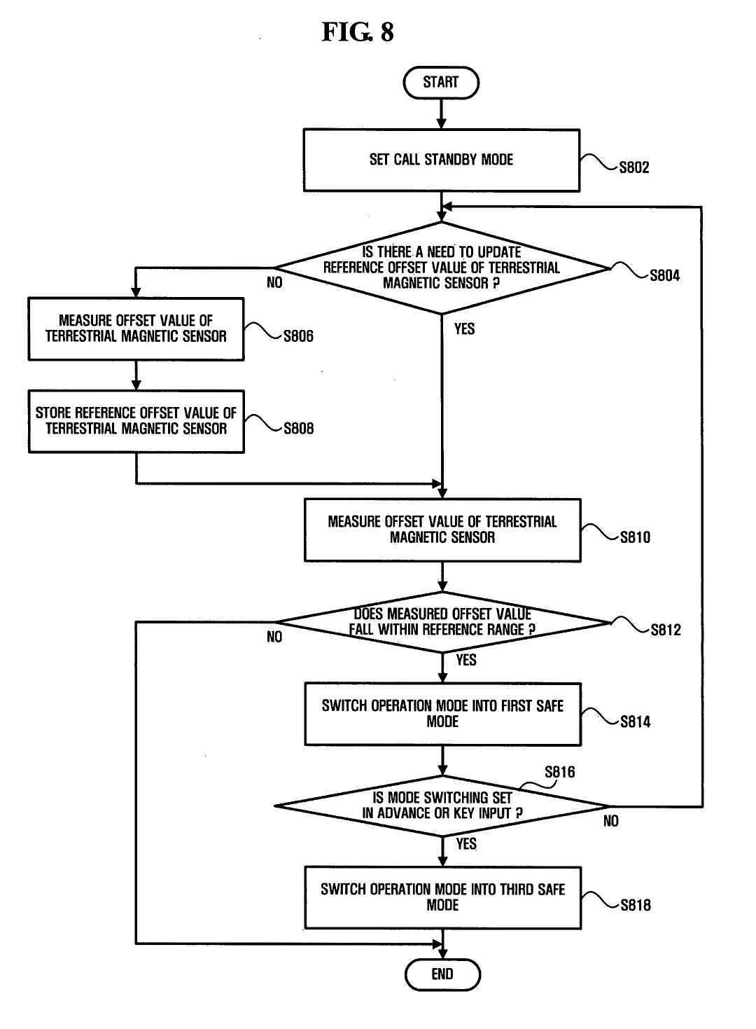

FIG. 8 is a flowchart showing a process of detecting, on the basis of a signal of the terrestrial magnetic sensor, whether or not a user having the mobile terminal is riding on a vehicle.

When an initialization operation required for the mobile terminal is completed, the mobile terminal enters a call standby mode in which a communication can be performed (Step S802).

In the call standby mode, when the offset value of the terrestrial magnetic sensor has to be updated according to the vehicle of the user, the mobile terminal determines whether or not to update the reference offset value of the terrestrial magnetic sensor mounted in the vehicle (Step S804). When a signal for requesting to update the offset value is input, the offset value of the terrestrial magnetic sensor at a place where the mobile terminal is located is measured (Step S806), and the offset value is stored as a new reference value (Step S808).

When the reference offset value stored in advance is used, Steps S804 to S808 may be omitted.

A reference offset value range that has an upper limit value and a lower limit value on the basis of the offset reference value may be defined in consideration of the noise level of the sensor and an appropriate margin, in addition to the reference offset value.

When the reference offset value of the terrestrial magnetic sensor is prepared (for example, newly updated or stored in advance), the comparison arithmetic unit 208 or 714 measures the offset value of the terrestrial magnetic sensor (Step S810) and determines whether or not the measured value falls within the reference range based on the reference offset value read from a memory (reference offset value storage unit) (Step S812).

If the measured value does not fall within the reference range, the control unit 210 or 716 keeps the call standby mode. If the measured value falls within the reference range, the control unit 210 or 716 judges that the user is riding in/on the vehicle with the mobile terminal and switches the operation mode into the first safe mode (Step S814).

When the operation mode is switched into the first safe mode, if a call is received, the mobile terminal outputs a ringtone (melody). According to the condition set by the user, the mobile terminal may transmit a text message or a voice message (voice recorded in advance) so as to inform a caller having another mobile terminal that the user having the mobile terminal according to an exemplary embodiment of the present invention is riding on the vehicle.

When the operation mode is switched into the first safe mode, the mobile terminal may be set to be switched into the third safe mode. When a predetermined key signal is input (Step S816), the operation mode may be switched from the first safe mode to the third safe mode by the control unit 210 or 716.

When the operation mode is switched into the third safe mode (Step S818), if a call is received, the mobile terminal may transmit a text message or a voice message to the mobile terminal possessed by a caller without outputting the ringtone (melody) so as to inform the caller having another mobile terminal that the user having the mobile terminal according to an exemplary embodiment of the present invention is riding in/on the vehicle in moving and will not respond to the call.

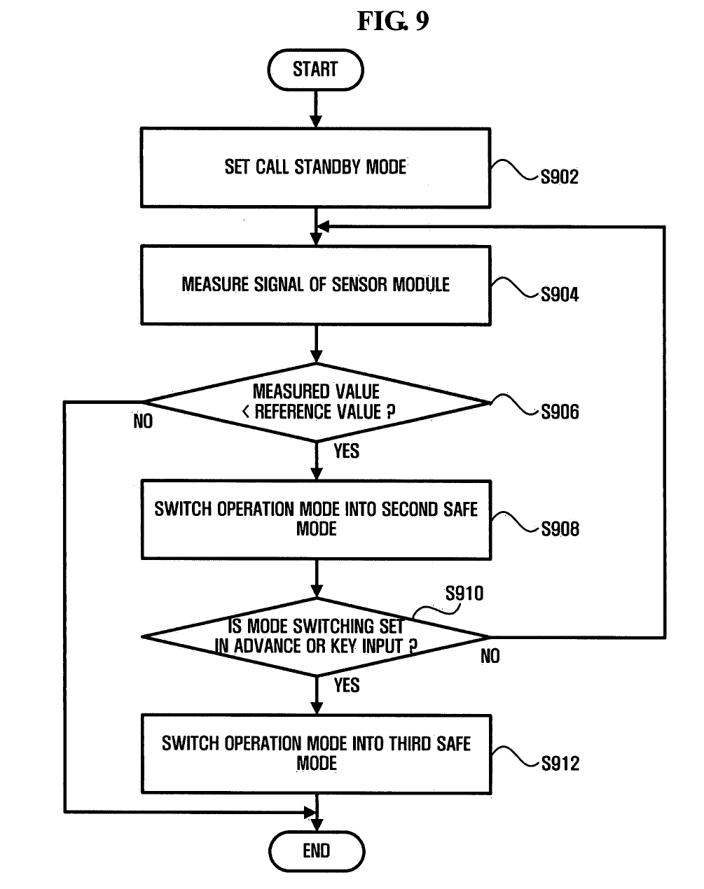

FIG. 9 is a flow chart showing, in a mobile terminal having the sensor module that further includes at least one of the acceleration sensor and the angle speed sensor, in addition to the terrestrial magnetic sensor, a process of detecting whether or not the vehicle, on which the user having the mobile terminal is riding, is moving on the basis of the signal of the sensor module.

The mobile terminal having the sensor module defines a reference sensor signal variation obtained by adding an appropriate margin to the noise level measured when the mobile terminal does not move in the call standby mode (Step S902), and stores the reference sensor signal variation in the first storage region 710 shown in FIG. 7.

In the call standby mode, the mobile terminal measures the signal of the sensor module (Step S904), defines a signal difference between the previous signal value and the currently measured signal value as the signal variation, and stores the defined signal variation in the second storage region 712 shown in FIG. 7.

Further, the comparison arithmetic unit 714 performs the comparison arithmetic of the measured sensor signal variation and the reference sensor signal variation. Then, the comparison arithmetic unit 714 judges, on the basis of the comparison arithmetic result, whether or not the measured sensor signal variation is larger than the reference sensor signal variation (Step S906).

As a result of the comparison operation, if the measured sensor signal variation is not larger than the reference sensor signal variation, the control unit 716 keeps the call standby mode. If the measured sensor signal variation is larger than the reference sensor signal variation, the control unit 716 switches the operation mode into the second safe mode (Step S908).

When the operation mode is switched into the second safe mode, if a call is received, the mobile terminal outputs the ringtone (melody). According to the condition set by the user, the mobile terminal may transmit a text message or a voice message (voice recorded in advance) so as to inform the caller having another mobile terminal that the user having the mobile terminal according to an exemplary embodiment of the present invention is riding in/on the vehicle.

When the operation mode is switched into the second safe mode, the mobile terminal may be set to be automatically switched into the third safe mode. When a predetermined key signal is input (Step S910), the operation mode may be switched from the second safe mode to the third safe mode by the control unit 716.

When the operation mode is switched into the third safe mode (Step S912), if a call is received, the mobile terminal may transmit a text message or a voice message (voice recorded in advance) to the mobile terminal of the caller without outputting the ringtone (melody) so as to inform the caller having another mobile terminal that the user having the mobile terminal according to an exemplary embodiment of the present invention is riding in/on the vehicle in moving and will not respond to the call.

If the operation mode is not in the call standby mode, the control unit 716 may not perform switching of the operation mode.

Although the present invention has been described in connection with a few exemplary embodiments of the present invention, it will be apparent to those skilled in the art that various modifications and changes may be made thereto without departing from the scope and spirit of the present invention. Therefore, it should be understood that the above exemplary embodiments are not limitative, but illustrative in all aspects.

According to the mobile terminal having the sensor module based on the terrestrial magnetic sensor and the method of controlling a mobile terminal according to exemplary embodiments of the present invention, it is possible to judge whether or not the measured offset value of the terrestrial magnetic sensor falls within the reference range by the comparison arithmetic. Therefore, it is possible to judge whether or not the user having the mobile terminal is riding in/on the vehicle.

Further, the mobile terminal measures the signal of the terrestrial magnetic sensor and compares the signal variation of the terrestrial magnetic sensor and a predetermined reference signal variation. Accordingly, it is possible to judge whether or not the user having the mobile terminal is riding in/on the vehicle in moving.

In addition, the sensor module having one or more sensors that are different from one another measures each of the sensor signals and compares the sensor signal variation and the predetermined reference sensor signal variation. Accordingly, it is possible to judge whether or not the user having the mobile terminal is riding in/on the vehicle in moving.

As a result, as described above, when the user is riding on the vehicle or is riding on the vehicle in moving, the state of the mobile terminal according to exemplary embodiment of the present invention is automatically informed to the mobile terminal of the caller through the text message or the voice message. Therefore, the user who has the mobile terminal and is riding in/on the vehicle does not mind a call to be received, such that safety of the user who is riding in/on the vehicle in moving can be secured.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter. In addition, code/instructions may include functional programs and code segments.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. The computer readable code/instructions may be executed by one or more processors. The computer readable code/instructions may also be executed and/or embodied in at least one application specific integrated circuit (ASIC) or Field Programmable Gate Array (FPGA).

In addition, one or more software modules or one or more hardware modules may be configured in order to perform the operations of the above-described exemplary embodiments

The term “module”, as used herein, denotes, but is not limited to, a software component, a hardware component, a plurality of software components, a plurality of hardware components, a combination of a software component and a hardware component, a combination of a plurality of software components and a hardware component, a combination of a software component and a plurality of hardware components, or a combination of a plurality of software components and a plurality of hardware components, which performs certain tasks. A module may advantageously be configured to reside on the addressable storage medium/media and configured to execute on one or more processors. Thus, a module may include, by way of example, components, such as software components, application specific software components, object-oriented software components, class components and task components, processes, functions, operations, execution threads, attributes, procedures, subroutines, segments of program code, drivers, firmware, microcode, circuitry, data, databases, data structures, tables, arrays, and variables. The functionality provided for in the components or modules may be combined into fewer components or modules or may be further separated into additional components or modules. Further, the components or modules can operate at least one processor (e.g. central processing unit (CPU)) provided in a device. In addition, examples of a hardware components include an application specific integrated circuit (ASIC) and Field Programmable Gate Array (FPGA). As indicated above, a module can also denote a combination of a software component(s) and a hardware component(s). These hardware components may also be one or more processors.

The computer readable code/instructions and computer readable medium/media may be those specially designed and constructed for the purposes of the present invention, or they may be of the kind well-known and available to those skilled in the art of computer hardware and/or computer software.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A method of controlling a mobile terminal, the method comprising:
extracting a reference offset value of a terrestrial magnetic sensor;
measuring an offset value of the terrestrial magnetic sensor;
comparing the measured offset value and the reference offset value; and
switching an operation mode into a first safe mode when the measured offset value falls within a reference range based on the reference offset value.

2. The method of claim 1, further comprising:
updating the reference offset value by the measured offset value.

3. The method of claim 1, further comprising:
outputting a ringtone while transmitting a voice message or a text message in response to a received call signal when the operation mode is switched into the first safe mode.

4. The method of claim 1, further comprising:
switching the operation mode from the first safe mode into a third safe mode; and
preventing output of a ringtone while transmitting a voice message or a text message in response to a received call signal when the operation mode is in the third safe mode.

5. At least one computer readable medium storing computer readable instructions that control at least one processor to implement the method of claim 1.

6. A method of controlling a mobile terminal, the method comprising:
extracting a reference signal variation of a sensor module having one or more sensors;
measuring a signal variation of the sensor module;
comparing the measured signal variation and the reference signal variation; and
switching an operation mode into a second safe mode when the measured signal variation is larger than the reference signal variation.

7. The method of claim 6, wherein the sensor module comprises a terrestrial magnetic sensor.

8. The method of claim 7, wherein the sensor module further comprises at least one of an acceleration sensor and an angular speed sensor.

9. The method of claim 6, further comprising:
transmitting a voice message or a text message when the operation mode is switched into the second safe mode and a call is received.

10. The method of claim 6, further comprising:
switching the operation mode from the second safe mode into a third safe mode;
preventing output of a ringtone while transmitting a voice message or a text message indicating that a user cannot receive the call in response to a received call when the operation mode is the third safe mode.

11. At least one computer readable medium storing computer readable instructions that control at least one processor to implement the method of claim 6.

12. A mobile terminal comprising:
a terrestrial magnetic sensor to measure an offset value of a sensed terrestrial magnetic signal;
a comparison arithmetic unit to compare the measured offset value and a reference offset value of the terrestrial magnetic sensor; and
a control unit to switch an operation mode into a first safe mode when the measured offset value falls within a reference range based on the reference offset value.

13. The mobile terminal of claim 12, wherein the reference offset value is updated by the measured offset value.

14. The mobile terminal of claim 12 further comprising:
an output unit to output a ringtone while transmitting a voice message or a text message in response to a received call signal when the operation mode is switched into the first safe mode.

15. The mobile terminal of claim 12, wherein the control unit switches the operation mode from the first safe mode to the third safe mode, and wherein the control unit further comprises:
an output unit to prevent output of a ringtone while transmitting a voice message or a text message in response to a received call signal when the operation mode is the third safe operation mode.

16. A mobile terminal comprising:
a sensor module to measure a signal variation using one or more sensors;
a comparison arithmetic unit to compare the measured signal variation and a reference signal variation; and
a control unit to switch an operation mode into a second safe mode when the measured signal variation is larger than the reference signal variation.

17. The mobile terminal of claim 16, wherein the sensor module comprises a terrestrial magnetic sensor.

18. The mobile terminal of claim 17, wherein the sensor module further comprises at least one of an acceleration sensor and an angular speed sensor.

19. The mobile terminal of claim 16, further comprising:
an output unit to transmit a voice message or a text message when the operation mode is switched into the second safe mode and a call is received.

20. The mobile terminal of claim 16, wherein the control unit switches the operation mode from the second safe mode to the third safe mode, and wherein the control unit further comprises:
an output unit, which prevents output of a ringtone while transmitting a voice message or a text message indicating that a user cannot receive the call in response to a received call when the operation mode is the third safe operation mode.

21. At least one computer readable medium storing computer readable instructions that control at least one processor to implement the method of claim 2.

22. At least one computer readable medium storing computer readable instructions that control at least one processor to implement the method of claim 3.

23. At least one computer readable medium storing computer readable instructions that control at least one processor to implement the method of claim 4.

24. At least one computer readable medium storing computer readable instructions that control at least one processor to implement the method of claim 7.

25. At least one computer readable medium storing computer readable instructions that control at least one processor to implement the method of claim 8.

26. At least one computer readable medium storing computer readable instructions that control at least one processor to implement the method of claim 9.

27. At least one computer readable medium storing computer readable instructions that control at least one processor to implement the method of claim 10.
